(19) United States
(12) Patent Application Publication
(10) Pub. No.: US 2006/0167885 A1
(43) Pub. Date: Jul. 27, 2006

(54) Method of establishing and carrying out communication between a data source and a user

(76) Inventor: Conny Larsson, Bjornbacken (SE)

Correspondence Address: YOUNG & THOMPSON, 745 SOUTH 23RD STREET, 2ND FLOOR, ARLINGTON, VA, 22202, US

(21) Appl. No.: 10/534,464

(22) PCT Filed: Nov. 6, 2003
(86) PCT No.: PCT/SE03/01716

§ 371 Date: Jan. 9, 2006

(30) Foreign Application Priority Data
Nov. 12, 2002 (SE) 0203331-4

(51) Int. Cl. G06F 7/00; G06F 17/30

(52) U.S. Cl. 707/10

(57) ABSTRACT

A method of establishing and carrying out communication between a data source and a user is effected via a fixed or a mobile network, wherein a program that handles a presentation to the user is placed in the user's terminal which, in turn, is connected, via a server, to a data source that contains data. The terminal handles data to and from the server such that when receiving information from a user the program clears this information from the layout and protocol and sends to the server and further to the data source solely interaction data. When receiving data from the data source the program places this data in a correct protocol for presentation to the user in the right presentation form and with the correct user layout.

The present invention relates to a method of establishing and carrying out communication between a data source and a user, where said communication is effected via a fixed or a mobile network.

Communication between a data source and a user normally involves the transportation of a large volume of information through the network for presentation on the user's terminal. It has become more usual recently to require information stored somewhere or the other, for example in a database or in an application in another network, to be presented in different ways, depending on the type of terminal used by the user at that moment in time, for instance in the form of a voice message, an SMS-message, an HTML-message or some like message. If a large volume of information shall be distributed on each occasion, there is created a distribution problem, particularly when the information shall be distributed through the medium of mobile communication.

Hitherto, when presenting information to a user the data source responsible for distribution of the information to respective users sends the information to the user's terminal together with all presentation information. As a result, the volume of information distributed on each occasion becomes very large and complex.

The object of the present invention is to provide in this regard an improved method that will enable communication to be established and carried out without always needing to transfer as much information as has hitherto been the case.

This object is achieved in accordance with the invention by means of a method in which a program that handles said presentation to the user is placed in the user's own terminal which, in turn, is connected, via a server, to the data-containing data source, wherein the terminal handles data to and from the server such that when receiving information from a user this information is cleared from the layout and protocol and solely interaction data is sent to the server and further to the data source. On the other hand, when receiving data from the data source this data is placed in a correct protocol for presentation to the user in the right presentation form and with the intended user layout.

As opposed to earlier conventional user communication systems, the inventive method is not primarily directed to the presentation of information to the user, but is directed to the interaction between user and data source.

The programs that manage the user interaction are thus placed in a server, meaning that the data source and its associated computer can be freed from the need to maintain the different interfaces with which data shall be presented to the user. Neither need the data or information be transported to the same extent in both directions through the network. The server also includes the program that handles data from the data source and that places the data in the right format for presentation to the user. This presentation may, for example, be in the form of a voice message, an SMS-message, an HTML-message or some corresponding message.

However, in accordance with the invention, that part of the program concerned with the presentation of the data information and the definition of the program-associated dialogue is transferred to the user's terminal upon his or her first contact with the server, and is loaded down in the terminal so that information as to how the presentation will take place and how the dialogue will be carried out does not need to be transferred to the terminal on each occasion, but need only be loaded down the first time the user connects his or her terminal to the server for the application in question, or when the application concerned has been updated in the server.

After the user's first contact with the server, or after the user's first contact with the server subsequent to updating of the application, no information as to how information will be presented or how the dialogue is defined need be sent to the terminal, but need only be sent between the server and the terminal and further between the server and the data source. The server is equipped with a program for linking data from the data source to the user, wherein said user data is distributed in a unitary form so that it can be placed in the correct layout for user presentation by the program in the user's terminal.

The user may conveniently have with the Operator that has the server and/or the data source behind the server a subscription for updating the program when new versions are released. In this case the arrangement may be such that the updated version is always transferred to the user's terminal upon the user's first connection with the server when a critical change has been made to the program. In such a case, this can be marked in the program that deals with the distribution of the updated programs from the server, so that the program will be aware of which cases an updating shall always be effected, obligatorily, on the occasion of said first connection. Otherwise the arrangement may be such that the updated version of the program is not transferred to the terminal until the terminal is connected to the server through the medium of a high bandwidth. This means, for instance, that a transfer will not take place if the terminal is connected via a mobile telephone, but the transfer will take place when the connection is made via a fixed network.

The server will therefore include several different programs for handling communication with different types of user terminals and for different applications, and will transfer to respective terminals the program that is relevant to the application and to the terminal concerned. The programs included in the server may also be designed to sort out data for different applications so as to enable said data to be sent to the data source always in a unitary fashion regardless of application, and so that data obtained from the data source can be converted for presentation in any one of the relevant applications whatsoever, i.e in the layout that the user knows and in which he/she wishes to receive the information.

The program that handles the presentation in the terminal is independent of the application used by the user.

The programs included in the terminal may also be designed to contain a certain amount of dialogue, so that the program is able to proceed to the next stage without needing to send inputted information back to the data source and await the next answer therefrom. For instance, this may apply to the presentation on a first page where the user is given the option of choosing between various alternatives and where subsequent dialogue pages that respond to the choices made by the user are stored in the terminal's program so that such responses can be presented directly to the user without needing to revert back to the data source. Certain other information from the user can also be handled in a corresponding manner, and if the program in the terminal is able to deal with the information from the user it does so in accordance with the instructions found in the program, whereas in any other case the information cleansed from the layout is sent via the server to the data source for an answer therefrom.

The dialogue facility is separated from presentation and layout information in the programs. This enables new presentation media to be readily added to existing applications in the server.

The server is designed to be able to manage several different applications for different users at one and the same time, and to distribute to respective users the program required for the user's terminal to be able to present the application to respective users with different interfaces. The server is also able to handle the same application for several different users, but to distribute programs to the user's terminals for presentation with different interfaces in respect of the different users.

Parts of the program included in the server may be identical for different applications and may therewith be used in respect of several different applications. One example of such a program part is a log-in procedure in which the user is given the opportunity of entering his/her user-ID and password in preparation for access to a given service. The program included in the terminal contains dialogue which informs the user how to log-in and allows the user to enter his/her user-ID and password, this information being separated by the terminal and forwarded to the application at the data source via the server for verification and to give the user access to further information.

Because those program parts that handle the presentation of information to the user thus create a user layout and also manage part of the dialogue with the user are placed in the user's own terminal, it is not necessary to transport this information between user's terminal and the data source, therewith reducing the transmission time and the transmission need in respect of the of the information to be transferred.

1. A method of establishing and carrying out communication between a data source and a user, where said communication is effected via a fixed or a mobile network, characterised in by placing a program that handles said presentation to the user in the user's own terminal which, in turn, is connected, via a server, to a data source that contains data; and in that the terminal handles data to and from the server such that when receiving information from a user the program clears this information from the layout and protocol and sends to the server and further to the data source solely interaction data, and, on the other hand, when receiving data from the data source places this data in a correct protocol for presentation to the user in the right presentation form and with the correct user layout.

2. A method according to claim 1, characterised in that the presentation handling program is independent of the application used by the user.

3. A method according to claim 1, characterised in that the program in the terminal also includes a dialogue facility which enables the facility to handle inputs from the user and to respond to the user without reverting back to the data source.

4. A method according to claim 1, characterised in that the program is downloaded into the terminal from the server on its first time of use.

5. A method according to claim 1, characterised in that when the program has been updated in the server, the updated program is downloaded from the server to the terminal when contact with the server is made subsequent to the program being updated.

6. (canceled)
